(19) United States
(12) Patent Application Publication
(10) Pub. No.: US 2018/0297815 A1
(43) Pub. Date: Oct. 18, 2018

(54) BEARING FOR DAMPING VIBRATIONS IN GUIDE RAILS OF AN ELEVATOR INSTALLATION

(71) Applicants: THYSSENKRUPP ELEVATOR AG, Essen (DE); thyssenkrupp AG, Essen (DE)

(72) Inventors: Michael KIRSCH, Kirchheim unter Teck (DE); Walter HOFFMANN, Niedernhausen (DE); Thomas KUCZERA, Leinfelden-Echterdingen (DE); Philippe GAINCHE, Großbettlingen (DE); Mike OBERT, Gernsbach (DE)

(73) Assignees: THYSSENKRUPP ELEVATOR AG, Essen (DE); thyssenkrupp AG, Essen (DE)

(21) Appl. No.: 15/569,514

(22) PCT Filed: Apr. 14, 2016
(86) PCT No.: PCT/EP2016/058248

§ 371 Date: Oct. 26, 2017

(30) Foreign Application Priority Data
May 5, 2015 (DE) 10 2015 208 288.1

(51) Int. Cl. B66B 7/02; F16F 1/36

(52) U.S. Cl. CPC B66B 7/024; F16F 1/36

(57) ABSTRACT

A device may be employed to damp vibrations in elevator installations. The device may include two metal plates that are spaced apart from one another by an insulator made of an elastomer. An inner side of at least one of the two metal plates may have a structure that is formed by projections. In some cases, both of the metal plates may include such structures, and the projections of each metal plate may engage with one another. Due to the flexibility of the insulator, the insulator can fit in the structure formed by the projections. Geometric sizes of the projections, arrangement of the projections, shapes of the projections, and spacings between the projections can all affect a level of damping.”

Damping bearings are used in elevator installations for minimizing vibrations which are conducted from the elevator car via guide rails into the building. Damping bearings are advantageous primarily when using a linear motor as the drive for elevator cars in an elevator installation, since no cables are present in this type of elevator and, therefore, all vertical forces, such as for example the weight force of the cabin, the drive force of the cabin and braking forces which act on the cabin are absorbed by the guide rails.

In order to ensure a lightweight elevator car when using damping bearings to reduce the vibrations, preferably as many components as possible should be attached so as to be integrated into an elevator rail fastening device on the shaft side.

Such damping bearings for reducing vibrations are disclosed in DE 102010054157 A1 and EP 2562120 A1. In both variants an insulating layer is arranged between two metal plates which in each case have a smooth surface. In both variants the two metal plates and the insulator located therebetween are connected together by at least one screw which penetrates both metal plates and the insulator located therebetween.

In the damping bearings for reducing vibrations in elevator installations known from the prior art, the thickness of the insulator which is arranged between the two metal plates and thus the spacing between the two metal plates is uniform in the direction at right angles to the main extension plane of the metal plates. The damping of the known bearings for reducing vibrations in elevator installations may be varied corresponding to the selection of the material and the thickness of the insulator. Varying the thickness of the insulator has the drawback that the overall size of the bearing is correspondingly altered as a result.

The vibrations which occur in the guide rail of an elevator installation are due both to the drive motor and to the traveling movement of the elevator car. In order to minimize the vibrations which are conducted via the guide rail into the building and at the same time to provide a high degree of traveling comfort for the passengers, the bearing in the vertical direction (z-direction), i.e. in the main direction of extension of the elevator shaft, should have a high level of damping and at the same time should be as stiff as possible in the horizontal plane (x-y plane).

So that such an effect may be achieved, the geometric dimensions of the bearing known from the prior art would have to be adapted. The greater the level of damping designed to be present in the vertical direction, the larger the bearing has to be in terms of extent in this direction. So that the bearing has a high degree of stiffness in the horizontal plane, the insulator has to be as thin as possible between the metal plates. If the known bearings were used, the geometric dimensions of the bearing would have to be continually readjusted according to the desired level of damping and thus also the entire structure of the elevator installation would have to be adapted thereto.

It is the object of the present invention to provide a device for damping vibrations in elevator installations which may be adapted to the required level of damping. In this case, the damping bearing is intended to be constructed to be as compact as possible. Moreover, the damping properties of the bearing are intended to be able to be varied without the external dimensions of the device being altered.

To achieve this object, the device is characterized in that two metal plates are spaced apart by an insulator made of an elastomer, wherein on its inner side facing the insulator at least one of the two metal plates has a structure which is formed by a plurality of projections. This device is also denoted hereinafter as an elastomer bearing. In a preferred embodiment, both metal plates have a structure, wherein the projections on the inner sides of the metal plates facing the insulator are arranged such that the projections of the two metal plates are in engagement with one another.

The insulator fits in the structure formed by projections of the at least one metal plate due to the flexibility of the insulator made of an elastomer. The insulator is in a positive connection with the at least one metal plate. By the positive connection, the elastomer is prevented from slipping. Due to the positive connection the spacing between the projections on the at least one metal plate corresponds to the thickness of the insulator between the projections. By a specific arrangement of the projections and specific spacings between the projections on the at least one metal plate, the thickness of the insulator and thus the damping property of the device may be adapted to requirements. In this manner, the damping action of the elastomer may be altered, wherein the overall dimensions of the damping bearing remain unaltered. Moreover, the projections may have different geometric shapes and dimensions. Thus the projections, for example, may be teeth. The structure formed by the projections, however, may also be in a line shape, i.e. the structure may for example have bars, wave-shaped lines or zig-zag lines. A combination of differently shaped and differently sized projections is also possible on at least one of the two metal plates. Thus, a plurality of variants are produced in order to adapt the damping optimally in one or more directions.

The spacings between two respective projections which are directly adjacent to one another on the inner side of at least one of the two metal plates facing the insulator may either always be of the same size or differ from one another at least partially in size. With an arrangement of projections which are spaced apart equally, a uniform damping is achieved. If the projections are arranged such that the spacings between two respective projections which are directly adjacent to one another differ from one another at least partially in size, it may be effected that the device partially has a higher level of damping or a lower level of damping.

The two metal plates and the insulator located therebetween are connected together at least once by means of fastening means. In the damping bearings which are known from the prior art, a fastening means penetrates both metal plates and the insulator located therebetween. This has the result, however, that vibrations from a first metal plate may be directly transmitted to the second metal plate via the fastening means. In order to prevent this, in the present invention the insulator is fastened to one respective metal plate by means of fastening means. Thus the insulator is connected to both metal plates but a rigid connection does not exist between the two metal plates. The metal plates are thus connected together via fastening means, but indirectly via the insulator. In this case, the fastening means which connect the insulator to a first metal plate are arranged offset relative to the fastening means which connect the insulator to the second metal plate. Thus no two fastenings are located directly opposite one another.

The following description of an advantageous embodiment of the invention serves for a more detailed explanation, in connection with the drawings. In detail:

FIG. 1 shows a partial view of a guide rail with a damping bearing attached thereto

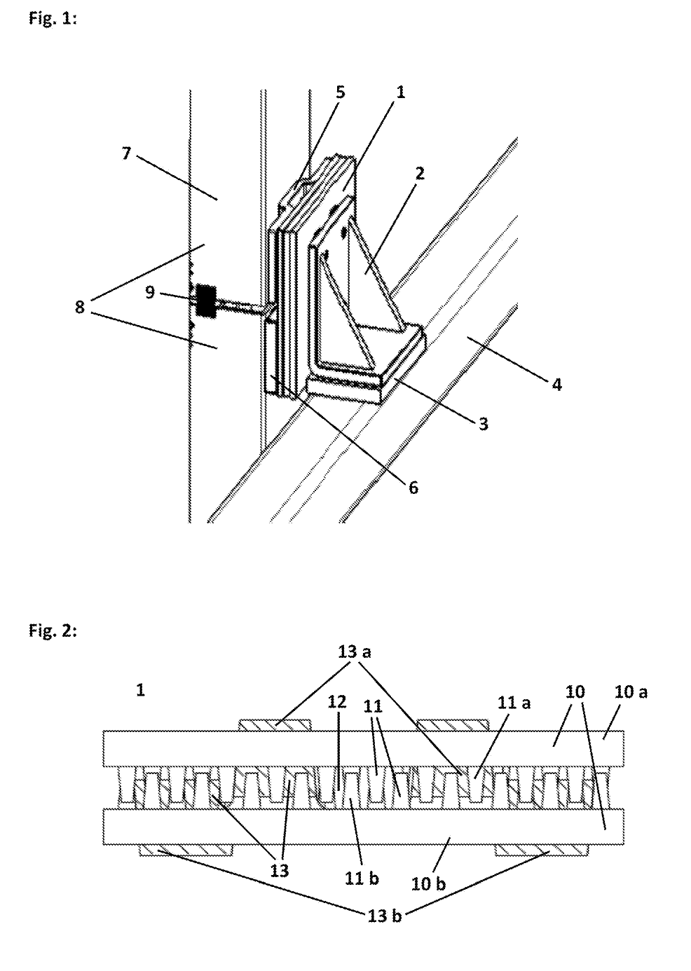

FIG. 2 shows a side view of an exemplary embodiment of a flexible bearing in a schematic view

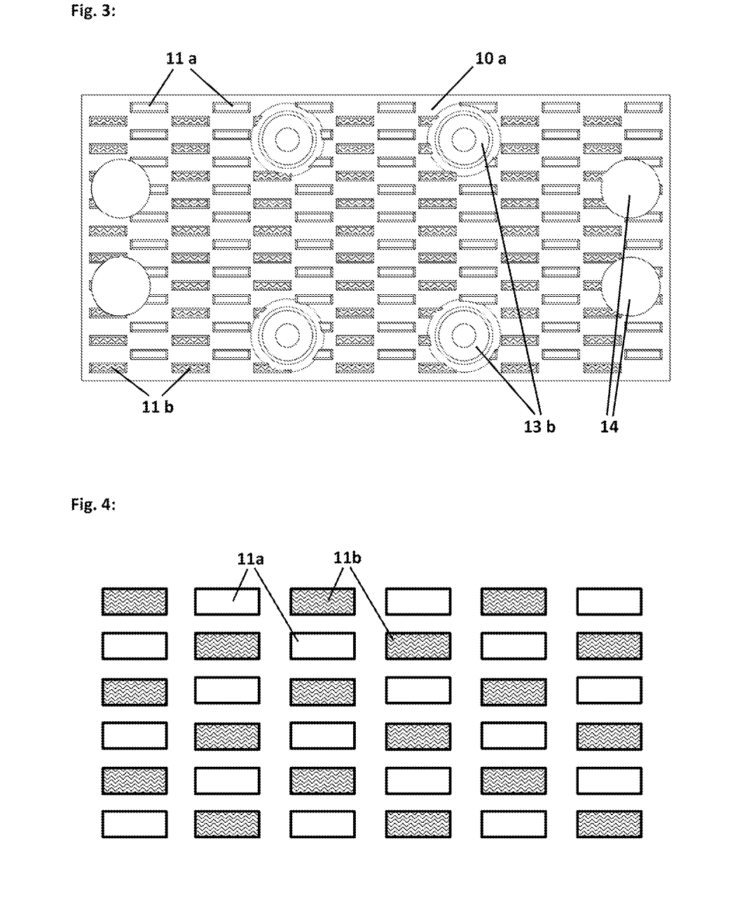

FIG. 3 shows a longitudinal section through the damping bearing shown in FIG. 2

FIG. 4 shows an exemplary embodiment of projections of two metal plates engaging with one another in cross section.

FIG. 1 shows a schematic view of a damping elastomer bearing 1 which is firstly fastened via an L-shaped fastening element 2 and a fastening element 3 to a wall mounting 4 and secondly is connected via the fastening elements 5, 6 to a guide rail 7.

In the view shown, the guide rail is made up of a plurality of rail elements 8, wherein in each case two rail elements are connected by a transition element 9. The fastening elements 5, 6 connect the damping elastomer bearing 1 in each case to one of the two rail elements 8.

The elastomer bearing 1 comprises two metal plates 10 which are spaced apart by an elastomer 12 located therebetween. By the fastening of a damping elastomer bearing 1 between a guide rail 7 and a wall fastening 4 in an elevator installation, vibrations which are produced during operation and which might be conducted via the guide rail 7 and the wall fastening 4 into the building are minimized.

FIG. 2 shows a side view of an embodiment of the damping elastomer bearing 1. The elastomer bearing 1 comprises two metal plates 10 which in each case on the inner side thereof facing the interior of the bearing has a structure which is formed by a plurality of projections 11. The arrangement of the projections 11 is designed such that the projections 11a of a first metal plate 10a and the projections 11b of a second metal plate 10b are in engagement with one another. The insulator made of an elastomer 12 which is located between the metal plates 10 is in a positive connection with the metal plates 10 and the projections 11 thereof.

In the embodiment shown, the projections 11 of the metal plates 10 are teeth of rectangular shape.

The bearing is held together by means of fastening means 13. The metal plates 10 in this case are not directly connected together. Since via a rigid connection of the two metal plates 10 vibrations might be conducted from the guide rail 7 to the wall fastening 4 without damping, the metal plates 10 including the insulator made of an elastomer 12 are connected together indirectly via fastening means 13. In the embodiment shown, the insulator made of an elastomer 12 and the metal plate 10a are penetrated by fastening means 13a and connected together thereby. Secondly, the insulator made of an elastomer 12 and the metal plate 10b are penetrated by the fastening means 13b and connected together thereby. The fastening means 13a and 13b are arranged spatially offset relative to one another. In this manner, the damping elastomer bearing 1 is held together via the fastening means 13 without vibrations being conducted in an undamped manner via the fastening means 13.

In FIG. 3 a cross section through FIG. 2 is shown. In the embodiment shown, the tooth-like projections 11a, 11b are arranged in rows on the metal plates 10a, 10b, wherein the rows of projections 11a of a first metal plate 10a are arranged offset relative to the rows of projections 11b of a second metal plate 10b. In the cross section shown in FIG. 3, the projections 11a and 11b are arranged through the elastomer bearing 1 such that in the main directions of extension of the metal plates 10a, 10b a row of projections 11a always alternates with a row of projections 11b, and diagonally to the main directions of extension a projection 11a always alternates with a projection 11b.

In the exemplary embodiment shown, the metal plates 10 comprise bores 14 at the points at which the fastening means 13 penetrate the metal plates 10, said fastening means also penetrating the insulator made of an elastomer 12. In this case the fastening means 13a penetrate the insulator made of an elastomer 12 and a metal plate 10a, whilst the fastening means 13b penetrate the insulator made of an elastomer 12 and a metal plate 10b.

FIG. 4 shows a further example of a possible arrangement of the tooth-like projections 11a and 11b in engagement. In the main directions of extension of the metal plates 10 a projection 11a always alternates with a projection 11b, whilst diagonally to the main directions of extension rows which either consist only of projections 11a or only of projections 11b alternate with one another.

The projections 11 shown in FIGS. 3 and 4 are configured in the shape of rectangular teeth. The teeth, however, may also have other geometric shapes. Both in FIG. 3 and in FIG. 4 the teeth are arranged symmetrically in rows with a uniform spacing from one another on the metal plates 10. The arrangement may correspond to the required damping property of the elastomer bearing 1 but may also be asymmetrical and have a non-uniform spacing between the teeth. The projections 11 do not necessarily have to be tooth-like. Projections 11 in the shape of bars, wave-shaped lines or zig-zag lines are also conceivable.

### LIST OF REFERENCE NUMERALS

Damping elastomer bearing 1

L-shaped fastening element 2

Fastening element 3

Wall mounting 4

Fastening element 5

Fastening element 6

Guide rail 7

Rail elements 8

Transition element 9

Metal plates 10a, b

Projections 11a, b

Insulator made of an elastomer 12

Fastening means 13a, b

Bores 14

1.-10. (canceled)

11. A device for damping vibrations in elevator installations, the device comprising a first metal plate and a second metal plate that are spaced apart from one another by an insulator comprised of an elastomer, wherein inner sides of the first and second metal plates face the insulator, wherein the inner side of at least the first metal plate has a structure that is formed by projections.

12. The device of claim 11 wherein the inner side of the second metal plate has a structure that is formed by projections, wherein the projections of the first and second metal plates are arranged such that the projections of the first and second metal plates are in engagement with one another.

13. The device of claim 11 wherein due to flexibility of the insulator the insulator fits in the structure formed by the projections such that the insulator is in a positive connection with the at least the first metal plate.

14. The device of claim 11 wherein an arrangement of the projections, geometric sizes and shapes of the projections, and spacings between the projections affect a level of damping.

15. The device of claim 11 wherein spacings between two respective projections that are directly adjacent to one another on the inner side of the at least the first metal plate have a same size.

16. The device of claim 11 wherein spacings between the projections that are directly adjacent to one another and that are arranged on the inner side of the at least the first metal plate differ from one another at least partially in size.

17. The device of claim 11 wherein the projections are in a line shape.

18. The device of claim 11 wherein the projections are tooth-like.

19. The device of claim 18 wherein the tooth-like projections are arranged in straight rows.

20. The device of claim 11 wherein the insulator is fastened to the first and second metal plates by way of fastening means, wherein the fastening means that fasten the insulator to the first metal plate are arranged offset relative to a main extension plane of the insulator relative to the fastening means that fasten the insulator to the second metal plate.
